(19) United States
(12) Patent Application Publication
(10) Pub. No.: US 2019/0357732 A1
(43) Pub. Date: Nov. 28, 2019

(54) SHOWER ROOM WITH A ROTATABLE CABINET

(71) Applicant: YUAN YEONG INDUSTRIAL CO., LTD., Taipei City (TW)

(72) Inventor: CHIH-HUNG HSIEH, TAIPEI CITY (TW)

(21) Appl. No.: 16/199,401

(22) Filed: Nov. 26, 2018

(30) Foreign Application Priority Data
May 22, 2018 (TW) 107206717

(51) Int. Cl. A47K 3/28; A61G 7/10

(52) U.S. Cl. CPC A47K 3/282; A61G 7/1003; A61G 7/1025

(57) ABSTRACT

A shower room has a compartment, a rotatable cabinet rotatably mounted in an opening of the compartment, a seat mounted on the rotatable cabinet, and a shower device mounted in the compartment. When the rotatable cabinet is rotated to a using state, the opening of the compartment is closed by the rotatable cabinet and the seat is disposed inside the compartment. When the rotatable cabinet is rotated to a moving state, the seat is disposed outside the compartment. A user sitting on the seat can be rotated into an interior space of the compartment along with the rotatable cabinet to have a shower, or be rotated to an exterior of the compartment to leave the rotatable cabinet. Therefore, it is convenient for people with mobility problems to enter or leave the shower room by sitting on the seat and rotating in place.

### CROSS-REFERENCE TO RELATED APPLICATIONS

This application is based upon and claims priority under 35 U.S.C. 119 from Taiwan Patent Application No. 107206717 filed on May 22, 2018, which is hereby specifically incorporated herein by this reference thereto.

### BACKGROUND OF THE INVENTION

### 1. Field of the Invention

The present invention relates to a shower apparatus, especially to a shower room for people with mobility problems.

### 2. Description of the Prior Art(s)

For people with mobility problems or people with disabilities, there are many inconveniences in daily life. In particular, in a society that is gradually aging, the number of elderly people with limited mobility is gradually increasing. Therefore, it is necessary for the public to provide more assistance and pay more attention those in need.

Regarding showering, conventional shower room are unable to meet the needs of the people with mobility problems and often causes trouble for people with mobility problems. Therefore, the people with mobility problems needs help from family members or nursing staffs to move them into the conventional shower room for showering and to move them to leave the conventional shower room after showering.

However, since an opening of the conventional shower room can only be passed by one person at a time, it is difficult for two people to pass the opening of the conventional shower room at a time and is stamina consuming as the family member or the nursing staff supports the person with mobility problems by the arm. Moreover, the family member or the nursing staff has to pay attention to prevent the person with mobility problems from hitting surrounding articles. Therefore, it is bound to cause problems for the family member or the nursing staff. In addition, since the person with mobility problems needs help from others while entering and leaving the shower room, it is hard to keep his personal privacy.

To overcome the shortcomings, the present invention provides a shower room with a rotatable cabinet to mitigate or obviate the aforementioned problems.

### SUMMARY OF THE INVENTION

The main objective of the present invention is to provide a shower room with a rotatable cabinet. The shower room has a compartment, the rotatable cabinet, a seat mounted on the rotatable cabinet, and a shower device mounted in the compartment. The compartment has an interior space defined in the compartment, and an opening formed through a side wall of the compartment. The rotatable cabinet is rotatably mounted in the compartment and is disposed at the opening of the compartment.

The rotatable cabinet is rotatable relative to the compartment and is selectively in a using state and a moving state. When the rotatable cabinet is rotated to the using state, the opening of the compartment is closed by the rotatable cabinet and the seat is disposed inside the compartment. When the rotatable cabinet is rotated to the moving state, the seat is disposed outside the compartment.

The shower room as described has the following advantages. With the rotatable cabinet, a user can sit on the seat that is mounted on the rotatable cabinet when the rotatable cabinet is in the moving state, and then is rotated into the interior space of the compartment along with the rotatable cabinet that is rotated to the using state. When the rotatable cabinet is in using state, the opening of the rotatable cabinet is closed and the user can have a shower. When the user has finished his showering, the rotatable cabinet is rotated back to the moving state to allow the user to leave the rotatable cabinet. The user only needs to sit on the seat and then the user can enter or leave the shower room by rotating in place. Therefore, it is convenient for people with mobility problems to enter or leave the shower room.

Other objectives, advantages and novel features of the invention will become more apparent from the following detailed description when taken in conjunction with the accompanying drawings.

### BRIEF DESCRIPTION OF THE DRAWINGS

FIG. 1 is a front perspective view of a shower room with a rotatable cabinet in accordance with the present invention;

FIG. 2 is a rear perspective view of the shower room in FIG. 1;

FIG. 3 is a schematic side view in partial section of the shower room in FIG. 1; and

FIGS. 4 to 6 are operational top views of the shower in FIG. 1.

### DETAILED DESCRIPTION OF THE PREFERRED EMBODIMENTS

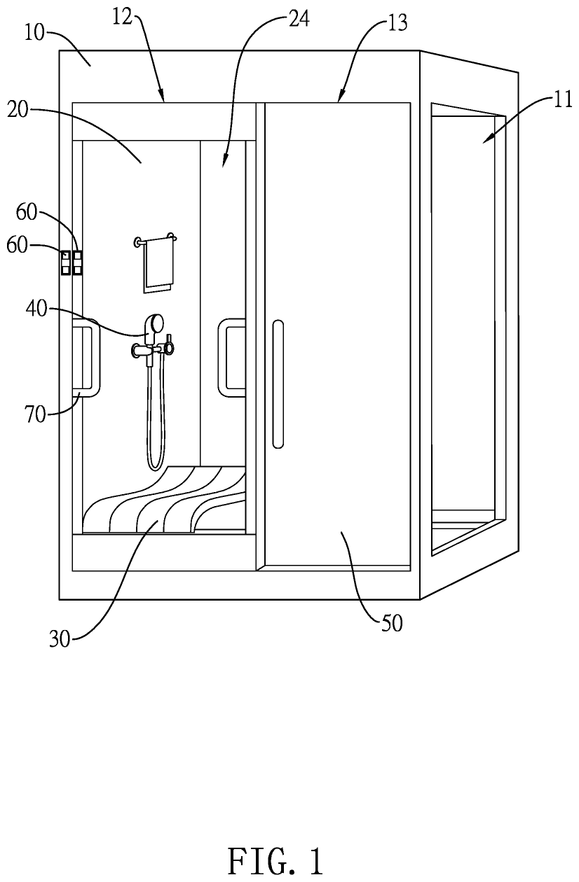

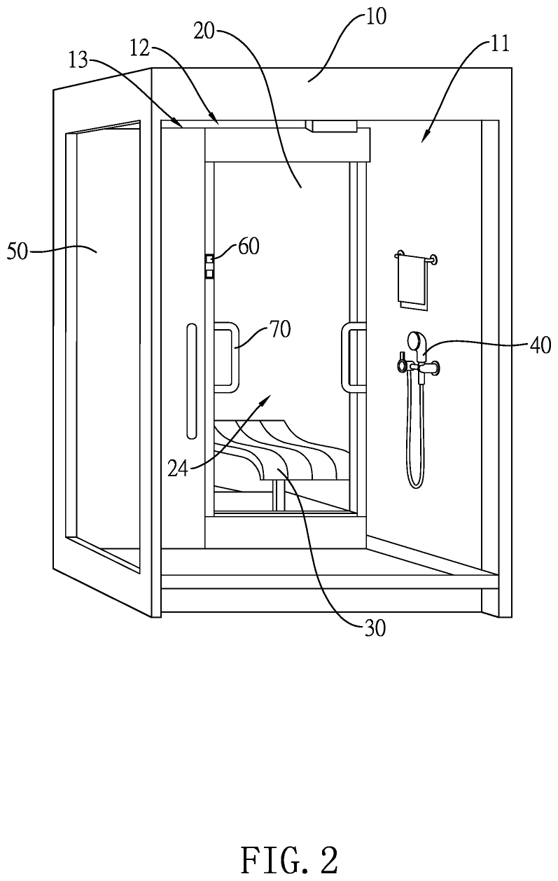

With reference to FIGS. 1 and 2, a shower room in accordance with the present invention relates to a compartment 10, a rotatable cabinet 20, a seat 30, and a shower device 40.

The compartment 10 has a side wall, an interior space 11, an opening 12, and an entrance 13. The interior space 11 is defined in the compartment 10. The opening 12 is formed through the side wall of the compartment 10. The entrance 13 is formed through the side wall of the compartment 10, is disposed next to the opening 12, and is for users to enter or to leave the compartment 10.

In the preferred embodiment, the entrance 13 laterally communicates with the opening 12. In other words, no partition is disposed between the entrance 13 and the opening 12. Accordingly, combination of the entrance 13 and the opening 12 forms a large opening. Alternatively, the entrance 13 and the opening 12 of the compartment 10 may be divided by a partition and do not laterally communicate with each other.

In the preferred embodiment, the compartment 10 is a movable capsule mounted in a bathroom. Alternatively, the compartment 10 may be formed in a bathroom by separating the bathroom with walls.

In the preferred embodiment, the shower room further comprises a movable door 50 selectively closing the entrance 13. Specifically, the movable door 50 is a hinged door and has a free side and a connecting side. The free side of the movable door 50 is disposed toward the opening 12 of the compartment 10. The connecting side of the movable door 50 is opposite to the free side of the movable door 50 and is pivotally connected to the compartment 10. Otherwise, the movable door 50 may be other types of doors, such as a sliding door, a folding door, and so forth.

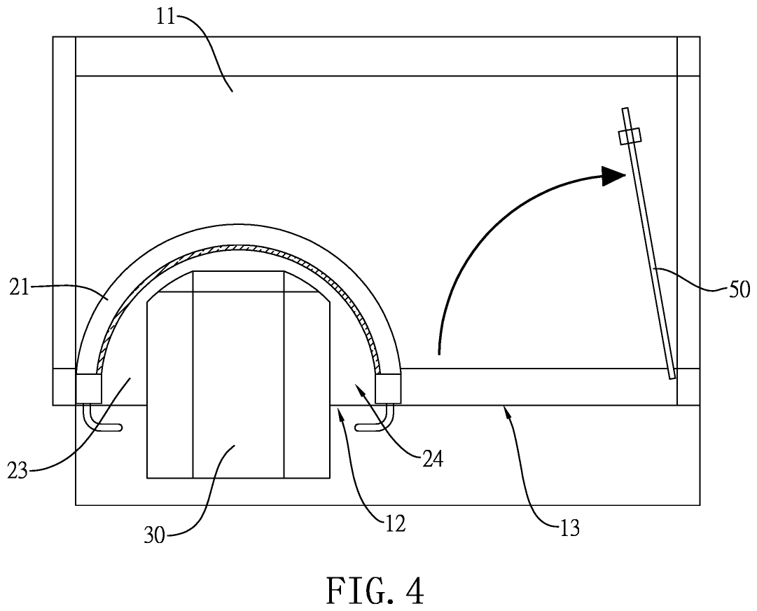

With further reference to FIGS. 4 to 6, the rotatable cabinet 20 is rotatably mounted in the compartment 10 and disposed at the opening 12 of the compartment 10.

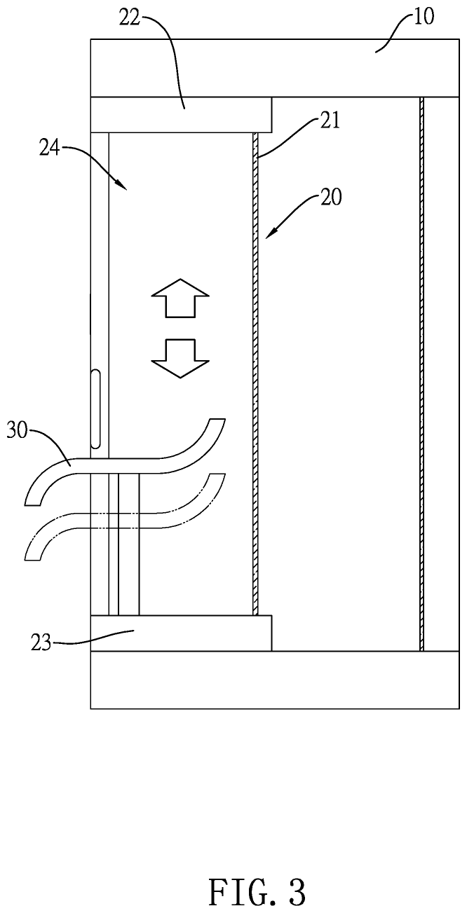

With further reference to FIGS. 2 and 3, the seat 30 is mounted on the rotatable cabinet 20. When the rotatable cabinet 20 rotates, the seat 30 rotates as well. In the preferred embodiment, the rotatable cabinet 20 is rotatable relative to the compartment 10 and is selectively in a using state and a moving state.

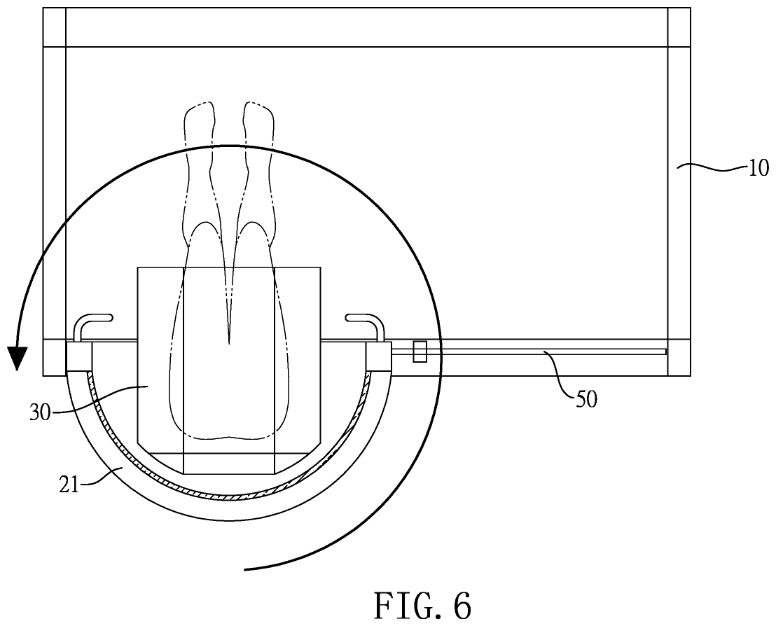

As shown in FIG. 6, when the rotatable cabinet 20 is rotated to the using state, the opening 12 of the compartment 10 is closed by the rotatable cabinet 20 and the seat 30 is disposed inside the compartment 10. In other words, when the user sits on the seat 30 and the rotatable cabinet 20 is at the using state, the user is disposed in and faces toward the interior space 11 of the compartment 10. Accordingly, the interior space 11 of the compartment 10 is closed by closing the opening 12 with the rotatable cabinet 20 and closing the entrance 13 with the movable door 50.

With reference to FIGS. 2 to 4, when the rotatable cabinet 20 is rotated to the moving state, the opening 12 of the compartment 10 is closed by the rotatable cabinet 20 and the seat 30 is disposed outside the compartment 10. In other words, when the user sits on the seat 30 and the rotatable cabinet 20 is at the moving state, the user is disposed in and faces toward an exterior of the compartment 10.

In the preferred embodiment, the rotatable cabinet 20 is rotated 180 degrees between the using state and the moving state along one side, and a height of the seat 30 is adjustable to be moved upwardly or downwardly, as shown in FIG. 3. Alternatively, the seat 30 may be rotated 360 degrees from the moving state to the using state and then back to the moving state.

With reference to FIGS. 1 to 4, the rotatable cabinet 20 includes a side wall 21, a top panel 22, a bottom panel 23, and a receiving chamber 24. The top panel 22 is formed on a top of the side wall 21 of the rotatable cabinet 20. The bottom panel 23 is formed on a bottom of the side wall 21 of the rotatable cabinet 20. The receiving chamber 24 is enclosed by the top panel 22, the bottom panel 23, and the side wall 21 of the rotatable cabinet 20. The seat 30 is disposed in the receiving chamber 24.

In other words, the receiving chamber 24 is a recessed space and forms a side opening on the rotatable cabinet 20. When the rotatable cabinet 20 is in the moving state, the side opening of the rotatable cabinet 20 faces toward the exterior of the compartment 10. When the rotatable cabinet 20 is in the using state, the side opening of the rotatable cabinet 20 faces toward the interior space 11 of the compartment 10. Furthermore, when the rotatable cabinet 20 is in the using state, the top panel 22, the bottom panel 23, and the side wall 21 of the rotatable cabinet 20 protrude to the exterior of the compartment 10.

In the preferred embodiment, the side wall 21 of the rotatable cabinet 20 is, but not limited to, an arc in lateral cross-section. The rotatable cabinet may be U-shaped in lateral cross-section. Moreover, in the preferred embodiment, the side wall 21 of the rotatable cabinet 20 is, but not limited to, made of transparent materials such as glass. In addition, the seat 30 that is disposed in the receiving chamber 24 is mounted on the bottom panel 23. The rotatable cabinet 20 further includes at least one handle 70 mounted on the side wall 21 of the rotatable cabinet 20.

In other embodiment, the top panel 22 and the bottom panel 23 may be omitted. Thus, the rotatable cabinet is formed as a wall and still can be rotated to change positions of the seat 30.

With reference to FIGS. 1 and 2, the shower room further comprises at least one switch 60. The at least one switch 60 is electrically connected with the rotatable cabinet 20 and controls a driving device, such as a motor, to selectively drive the rotatable cabinet 20 to rotate relative to the compartment 10 and to adjust the height of the seat 30.

The shower room may comprise one switch 60 that controls rotation of the rotatable cabinet 20 and the height of the seat 30. In the preferred embodiment, the shower room comprises two switches 60 that control the rotation of the rotatable cabinet 20 and the height of the seat 30 respectively. The two switches 60 are, but not limited to, mounted on the compartment 10 and the rotatable cabinet 20 respectively. Considerations of where to set the at least one switch 60 are facilities in reaching and operating the at least one switch 60. Otherwise, the at least one switch 60 can be omitted as long as the rotatable cabinet 20 can be rotated and the height of the seat 30 can be adjusted. For instance, the rotatable cabinet 20 may be rotated manually and the height of the seat 30 may be adjusted manually.

The shower device 40 is mounted in the compartment 10 and includes shower facilities such as a shower head and the like.

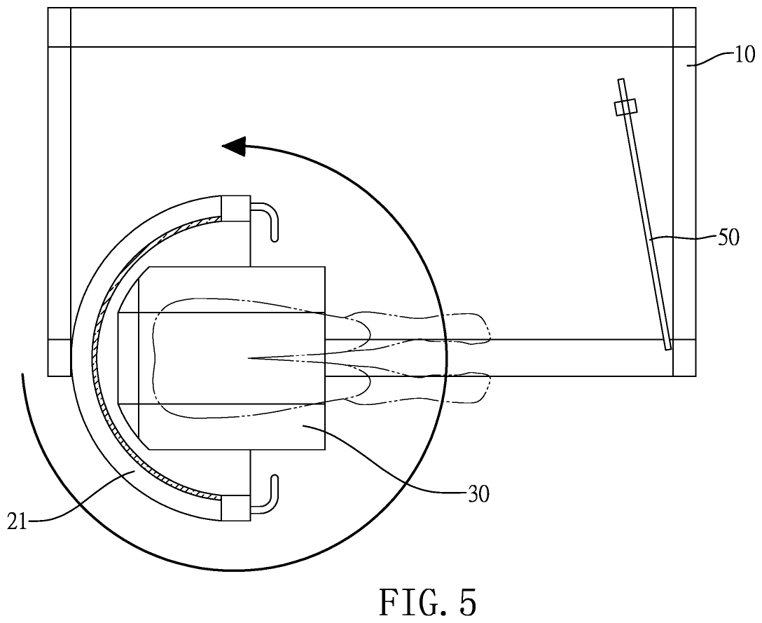

With reference to FIG. 4, when using the shower room of the present invention, the rotatable cabinet 20 is rotated to the moving state and the user sit on the seat 30 by help from others or by himself With further reference to FIGS. 5 and 6, then the rotatable cabinet 20 along with the user is rotated into the interior space 11 of the compartment 10. Thus, the rotatable cabinet 20 closes the opening 12 of the compartment 10, the seat 30 is disposed inside the compartment 10, and the rotatable cabinet 20 is in the using state. When the user has finished his showering, the rotatable cabinet 20 is rotated back to the moving state. Accordingly, an entire showering process is completed. During the showering process, the user only needs to sit on the seat 30, and then the user can enter or leave the shower room by rotating in place. Therefore, it is convenient for people with mobility problems to enter or leave the shower room.

For the compartment 10 having the opening 12 communicating with the entrance 13, the movable door 50 can be opened, so as to allow legs of the user who sits on the seat 30 to pass the entrance 13 when the rotatable cabinet 20 is being rotated. Thus, the shower room of the present invention is able to be suitable for the users with different body proportions.

Alternatively, for the compartment 10 that the opening 12 and the entrance 13 are divided by the partition, a width of the opening 12 and sizes of the rotatable cabinet 20 and the seat 30 can be determined according to the body proportion of a specific user in advance, so as to prevent the user from hitting the side wall 12 of the compartment 10.

During the showering process, the user is able to adjust the height of the seat 30 and the rotation of the rotatable cabinet 20 through the at least one switch 60 without the help from others.

During the showering process, the user can hold the at least one handle 70 on the side wall 21 of the rotatable cabinet 20 when the rotatable cabinet 20 is being rotated, such that the user can stably sit on the seat 30.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A shower room comprising:
a compartment having
an interior space defined in the compartment; and
an opening formed through a side wall of the compartment;
a rotatable cabinet rotatably mounted in the compartment and disposed at the opening of the compartment;
a seat mounted on the rotatable cabinet; and
a shower device mounted in the compartment;
wherein
the rotatable cabinet is rotatable relative to the compartment and is selectively in a using state and a moving state;
when the rotatable cabinet is rotated to the using state, the opening of the compartment is closed by the rotatable cabinet and the seat is disposed inside the compartment; and
when the rotatable cabinet is rotated to the moving state, the seat is disposed outside the compartment.

2. The shower room as claimed in claim 1, wherein
the compartment further has an entrance formed through the side wall of the compartment and laterally communicating with the opening; and
the shower room further comprises a movable door selectively closing the entrance.

3. The shower room as claimed in claim 2, wherein the movable door has
a free side disposed toward the opening of the compartment; and
a connecting side being opposite to the free side of the movable door and pivotally connected to the compartment.

4. The shower room as claimed in claim 1, wherein
the rotatable cabinet includes
a side wall;
a top panel formed on a top of the side wall of the rotatable cabinet;
a bottom panel formed on a bottom of the side wall of the rotatable cabinet; and
a receiving chamber enclosed by the top panel, the bottom panel, and the side wall of the rotatable cabinet; and
the seat is disposed in the receiving chamber;
wherein when the rotatable cabinet is in the using state, the top panel, the bottom panel, and the side wall of the rotatable cabinet protrude to an exterior of the compartment.

5. The shower room as claimed in claim 2, wherein
the rotatable cabinet includes
a side wall;
a top panel formed on a top of the side wall of the rotatable cabinet;
a bottom panel formed on a bottom of the side wall of the rotatable cabinet; and
a receiving chamber enclosed by the top panel, the bottom panel, and the side wall of the rotatable cabinet; and
the seat is disposed in the receiving chamber;
wherein when the rotatable cabinet is in the using state, the top panel, the bottom panel, and the side wall of the rotatable cabinet protrude to an exterior of the compartment.

6. The shower room as claimed in claim 3, wherein
the rotatable cabinet includes
a side wall;
a top panel formed on a top of the side wall of the rotatable cabinet;
a bottom panel formed on a bottom of the side wall of the rotatable cabinet; and
a receiving chamber enclosed by the top panel, the bottom panel, and the side wall of the rotatable cabinet; and
the seat is disposed in the receiving chamber;
wherein when the rotatable cabinet is in the using state, the top panel, the bottom panel, and the side wall of the rotatable cabinet protrude to an exterior of the compartment.

7. The shower room as claimed in claim 4, wherein the side wall of the rotatable cabinet is an arc in lateral cross-section.

8. The shower room as claimed in claim 1, wherein
when then rotatable cabinet is in the moving state, the opening of the compartment is closed by the rotatable cabinet; and
the rotatable cabinet is rotated 180 degrees between the using state and the moving state.

9. The shower room as claimed in claim 2, wherein
when then rotatable cabinet is in the moving state, the opening of the compartment is closed by the rotatable cabinet; and
the rotatable cabinet is rotated 180 degrees between the using state and the moving state.

10. The shower room as claimed in claim 3, wherein
when then rotatable cabinet is in the moving state, the opening of the compartment is closed by the rotatable cabinet; and
the rotatable cabinet is rotated 180 degrees between the using state and the moving state.

11. The shower room as claimed in claim 1, wherein a height of the seat is adjustable to be moved upwardly or downwardly.

12. The shower room as claimed in claim 2, wherein a height of the seat is adjustable to be moved upwardly or downwardly.

13. The shower room as claimed in claim 3, wherein a height of the seat is adjustable to be moved upwardly or downwardly.

14. The shower room as claimed in claim 1, wherein the shower room further comprises at least one switch electrically connected with the rotatable cabinet and selectively driving the rotatable cabinet to rotate relative to the compartment.

15. The shower room as claimed in claim 2, wherein the shower room further comprises at least one switch electrically connected with the rotatable cabinet and selectively driving the rotatable cabinet to rotate relative to the compartment.

16. The shower room as claimed in claim 3, wherein the shower room further comprises at least one switch electrically connected with the rotatable cabinet and selectively driving the rotatable cabinet to rotate relative to the compartment.

17. The shower room as claimed in claim 11, wherein the shower room further comprises at least one switch electrically connected with the rotatable cabinet and selectively driving the rotatable cabinet to rotate relative to the compartment and to adjusting the height of the seat.

18. The shower room as claimed in claim 1, wherein the rotatable cabinet further includes at least one handle.

19. The shower room as claimed in claim 2, wherein the rotatable cabinet further includes at least one handle.

20. The shower room as claimed in claim 3, wherein the rotatable cabinet further includes at least one handle.
